(19) United States
(12) Patent Application Publication
(10) Pub. No.: US 2007/0005582 A1
(43) Pub. Date: Jan. 4, 2007

(54) BUILDING OF DATABASE QUERIES FROM GRAPHICAL OPERATIONS

(75) Inventors: Roman Navratil, Prague 9 (CZ); Petr Stluka, Prague (CZ)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/160,300

(22) Filed: Jun. 17, 2005

(51) Int. Cl. G06F 17/30

(52) U.S. Cl. 707/4

(57) ABSTRACT

Methods, systems, and computer program products for data analysis. A collection of data points or data derived from a collection of data points is graphically displayed. A user is allowed to graphically select a portion of the graphic display. A database query is then constructed based upon the user's graphical selection.

### FIELD

The present invention is related to the field of database analysis. More specifically, the present invention is related to the manipulation of data within a database.

### BACKGROUND

Structured query language (SQL) is generally considered to be a fourth generation database language. SQL may be used to build a database and perform simple to complex queries of a database. Like most software languages, learning and understanding the script used in SQL can be a challenge. It would be useful to render SQL more accessible to a wider audience.

### SUMMARY

The present invention includes, in illustrative embodiments, methods, systems, and computer program products for data analysis. In an illustrative embodiment, a collection of data points or data derived from a collection of data points is graphically displayed. A user is allowed to graphically select a portion of the graphic display. A database query is then constructed based upon the user's graphical selection. Additional embodiments include computer program products and systems for performing these and other methods.

### BRIEF DESCRIPTION OF THE DRAWINGS

FIG. 1 is an example data query using structured query language;

FIG. 2 is a block diagram for an illustrative embodiment;

FIGS. 3A-3B illustrate graphical data point selection in an illustrative embodiment;

FIGS. 4-7 illustrate graphical selection of data points from a scatter plot matrix;

FIGS. 8A-8B show a highly simplified graphical selection of data points within a scatter plot matrix;

FIG. 9 illustrates parallel plotting of data;

FIGS. 10-11 illustrate graphical selection of data points in parallel plots corresponding to the parallel plot of FIG. 9;

FIG. 12 shows graphical selection of data points from a mosaic representation of data;

FIG. 13 illustrates graphical selection of data from a histogram;

FIG. 14 illustrates graphical selection of data from a probability density function representation of data; and

FIGS. 15-16 illustrate graphical selection for SQL statement building from trend plots.

### DETAILED DESCRIPTION

The following detailed description should be read with reference to the drawings. The drawings, which are not necessarily to scale, depict illustrative embodiments and are not intended to limit the scope of the invention.

As used herein, the term “data point” is used to refer to a database element having one or more dimensions. A data point may be represented graphically in several different ways depending upon the graphical format. For example, a data point, when displayed in a parallel coordinate system, may be represented by a multi-segment line intersecting a number of parallel axes each representing a different dimension of the data point. However, when displayed on an X-Y coordinate plot, a data point may be shown as a point or symbol. Also, when displayed in a scatter plot matrix, a data point may be shown as a point or symbol on each of several plots. Data points may also be represented graphically using information derived from one or more data points including, for example, histogram or probability density function plotting.

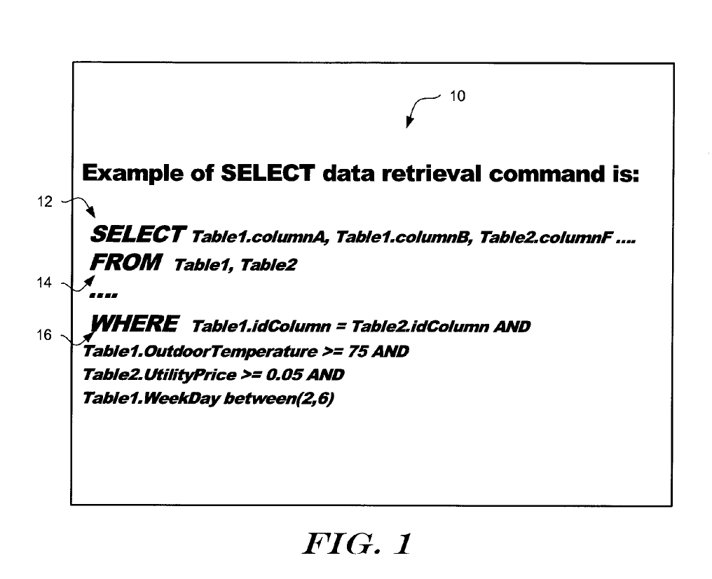

FIG. 1 is an example data query using structured query language (SQL). The data query is shown at 10 and includes various parts. Portions of data to analyze are selected as shown at 12 from data sets as shown at 14. Conditions are entered in a “where” statement, as shown at 16. It can be seen that, even from the simple query in FIG. 1, the SQL data query requires knowledge of the SQL terminology, format and syntax, as well as an understanding of how data is mapped in a database. As a result, a skilled SQL consultant is often used by a party seeking to analyze a database, adding to the costs of data analysis.

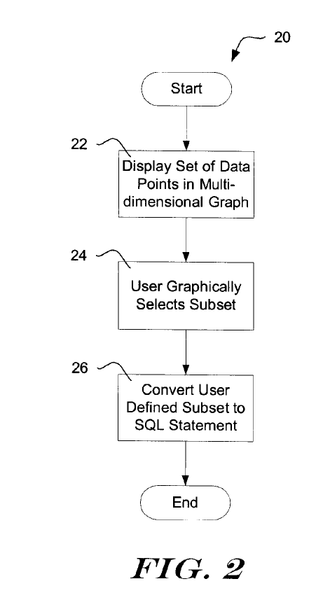

FIG. 2 is a block diagram for an illustrative embodiment. The illustrative method is shown generally at 20 and may be embodied as a method or in various forms including as a computer program or computer program product, or in a computer system programmed to perform the method steps. From a start block, the method begins by graphically displaying data including data from a plurality of data points, as shown at 22. The user then graphically selects a subset of the set of data points, as shown at 24. Next, the user-defined subset is converted into an SQL statement, as shown at 26. The SQL statement may then be executed or used in any suitable fashion.

In various embodiments, the present invention may be used to provide added functionality or to simplify functionality in database use. For example, graphical selection of data points from a graphical representation of data encompassing a set of data points may help allow various operations to be performed. Data points having a specific relationship may be identified by observing their graphic representation. Trends or correlations of data points may also be identified. By graphically representing the data, outliers may be more easily removed, identified, or analyzed. Distributions of data points or groups of data points may be more easily identified, and data points having specific distributions may be selected for further query. Data clusters and patterns may also be more readily identified and selected. Root cause analysis may be aided using embodiments of the present invention, and bottlenecks in data flow or operations related to a set of data points may be more easily identified.

Following are several examples illustrating different ways data may be graphically displayed. In some embodiments the data is displayed as a number of data points. In other embodiments, data is displayed more indirectly in a manner representative of a plurality of data points, for example, in a probability density function graph or a histogram.

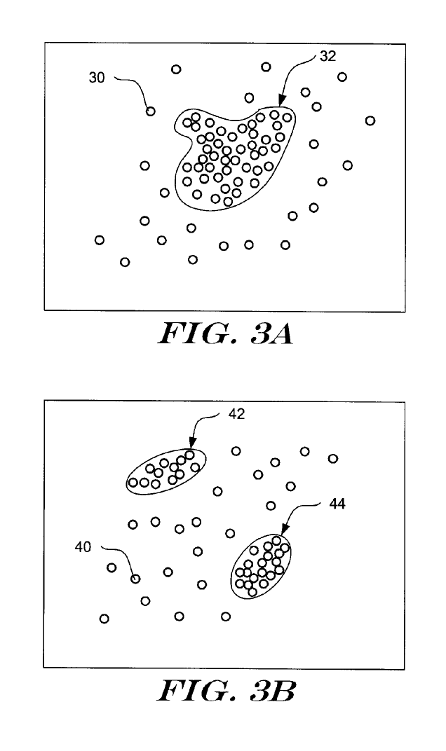

FIGS. 3A-3B illustrate graphical data point selection in an illustrative embodiment. Referring to FIG. 3A, a number of data points are represented as shown at 30 in what may be, for example, a scatter or X-Y plot. A user may use a cursor, a line tool, a mouse directed element, or any other suitable input device or method to define a subset 32 of the data points 30. The edges of the subset 32 may be curved, straight, or irregular, as desired. If desired, data points 30 may be selected for inclusion in the subset 32 individually, for example, by clicking on individual data points 30. The data points 30 may be graphically “brushed” by a user-controlled cursor, for example, if the user uses a mouse or trackball.

Referring to FIG. 3B, data points 40 are again shown graphically. In this example, a subset of data points includes first and second discontinuous collections of data points, as shown at 42 and 44, within a single plot. In some cases, a union of these points may be selected for further analysis.

In illustrative embodiments of the present invention associated with FIGS. 3A-3B, SQL statements are generated from the graphical selections. Specifically, SQL statements that capture the data points in the subset 32 or in the subset defined by first and second discontinuous collections of data points 42, 44 are generated.

The SQL statements that are generated from the graphical selections may take multiple forms. For example, an SQL statement may describe individual data points that have been graphically selected simply by identifying a list of such selected data points using unique column identifiers for the selected data points. In another embodiment, an SQL statement may describe data parameters for selected data points.

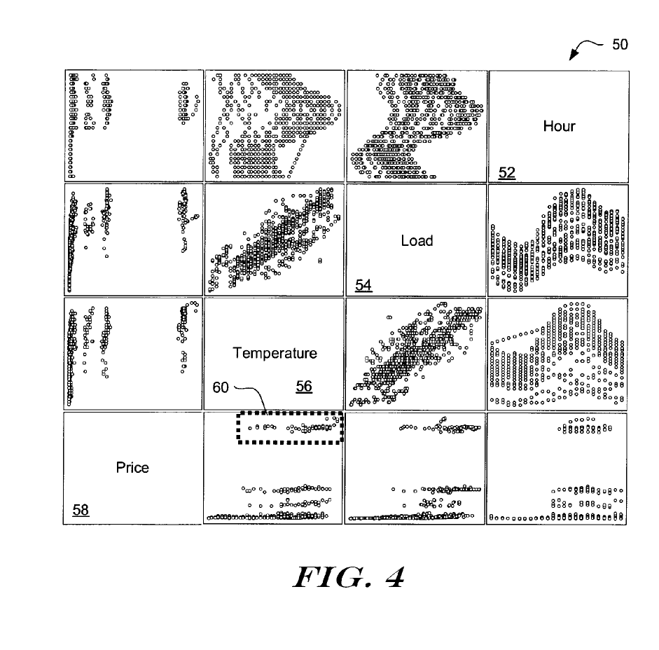

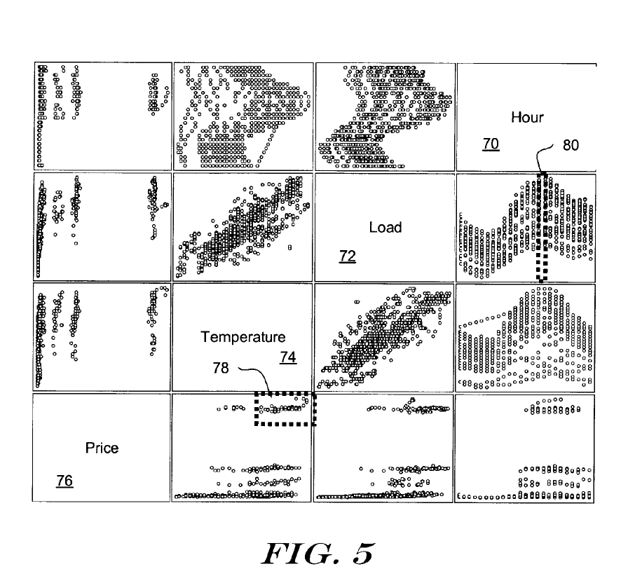

FIGS. 4-7 illustrate graphical selection of data points from a scatter plot matrix. Referring now to FIG. 4, a scatter plot matrix having four dimensions is shown at 50. The dimensions, for illustrative purposes, relate to a cooling, heating and power type system. For illustrative purposes, the scale used in constructing the scatter plot matrix is omitted. The display may be performed on a graphical user interface, such as a computer screen.

The dimensions illustratively include hour 52, load 54, temperature 56, and price 58. In the illustrative embodiment, a user graphically selects a number of data points as shown within the box 60. In the illustrative embodiment, the following SQL statement is then generated:

```
  SELECT Table1.Hour, Table1.Load, Table1.OutdoorTemperature,
  Table1.UtilityPrice FROM Table1
  WHERE (Table1.OutdoorTemperature>=67 AND
Table1.OutdoorTemperature<=99) AND (Table1.UtilityPrice>=0.28 AND
Table1.UtilityPrice<=0.32)
```

In an illustrative example, the SQL statement is generated by a software program product having an instruction set for interpreting the graphical data selected to construct the SQL statement. For example, the boundaries of area 60 may be identified and translated into the SQL statement.

Referring now to FIG. 5, another scatter plot matrix is shown having the multiple plots for dimensions including hour 70, load 72, temperature 74 and price 76. In this example, two graphical selection areas are defined at 78, which is in a price 76 and temperature 74 plot, and at 80, which is in a load 72 and hour 70 plot. The two graphical selection areas 78, 80 are then subjected to a conjunction step, such that the subset of selected data points includes data points that are in both area 78 and area 80. The resulting SQL statement is the following:

```
  SELECT Table1.Hour, Table1.Load, Table1.OutdoorTemperature,
  Table1.UtilityPrice FROM Table1
  WHERE ((Table1.OutdoorTemperature>=67 AND
Table1.OutdoorTemperature<=99) AND (Table1.UtilityPrice>=0.28 AND
Table1.UtilityPrice<=0.32)) AND ((Table1.Hour>=14 and
Table1Hour<=15) AND
(Table1.Load>=43728 AND Table1.Load<=93082))
```

The underlined AND indicates that the combination is subject to a conjunction step.

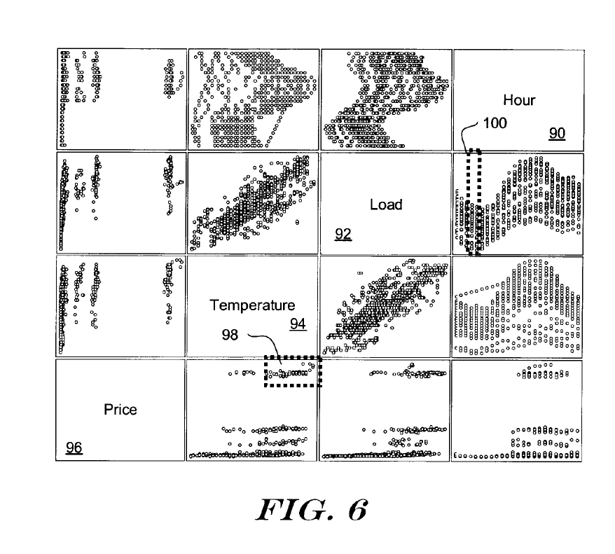

Referring now to FIG. 6, yet another scatter plot matrix is shown having the multiple plots again for dimensions including hour 90, load 92, temperature 94 and price 96. In this example, two graphical selection areas are defined, including at 98, which is in a price 96 and temperature 94 plot, and 100, which is in a load 92 and hour 90 plot. In the illustrative embodiment, the two graphical selection areas are then subjected to a union step, such that the subset of selected data points includes data points that are in either area 98 or area 100. The resulting SQL statement is the following:

```
  SELECT Table1.Hour, Table1.Load, Table1.OutdoorTemperature,
  Table1.UtilityPrice FROM Table1
  WHERE ((Table1.OutdoorTemperature>=67 AND
Table1.OutdoorTemperature<=99) AND (Table1.UtilityPrice>=0.28 AND
Table1.UtilityPrice<=0.32)) OR ((Table1.Hour>=14 and
Table1Hour<=15) AND
(Table1.Load>=43728 AND Table1.Load<=93082))
```

The underlined OR indicates that the combination is subject to a union step. In illustrative embodiments, in addition to AND and OR functions, exclusive-OR, AND-NOT, and other suitable functions may be used as well.

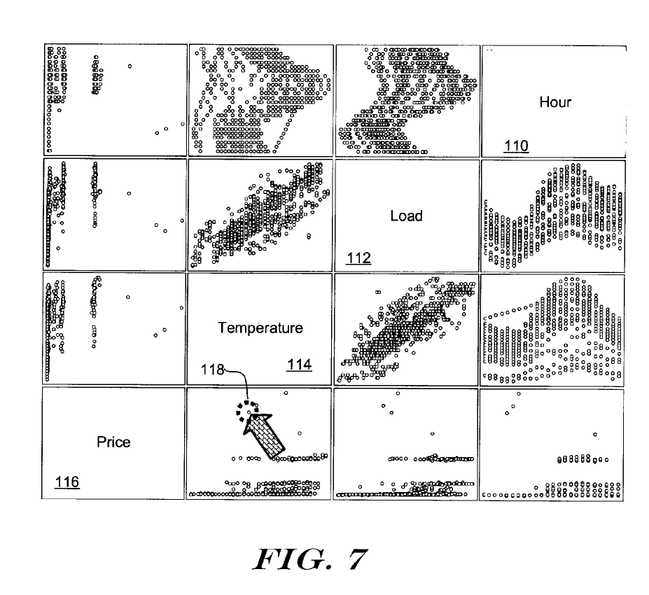

Referring now to FIG. 7, a scatter plot matrix is shown having dimensions including hour 110, load 112, temperature 114 and price 116. A single data point is selected graphically, as shown at 118. This time there are alternative ways in which the SQL statement may be generated. In a first example, this SQL statement is generated:

SELECT Table1.Hour, Table1.Load, Table1.OutdoorTemperature,
Table1.UtilityPrice FROM Table1
WHERE Table1.OutdoorTemperature=78.1 AND
Table1.UtilityPrice=0.65

It should be noted that more than one data point can be captured using the above SQL statement. In an alternative example, only a single point can be captured with the SQL statement as follows:

SELECT Table1.Hour, Table1.Load, Table1.OutdoorTemperature,
Table1.UtilityPrice FROM Table1
WHERE Table1.Date=’7/29/1999 03:59:57’

The “where” statement reflects a unique column identifier for the data point. Alternatively, if a set of data points is numbered within a set of database elements, the element number for a data point may be used as a unique column identifier. In an illustrative embodiment, whether a single data point is captured using the first or the second alternative may depend upon the manner in which the data point is graphically selected. For example, if the data point is “clicked” on, the second alternative may be used, while if the data point happens to be highlighted within a user-defined box or region, the first alternative may be used.

In some embodiments, the above methods may be used within a context that allows user selection of different formats for constructing SQL statements for graphically selected subsets of data. For example, a computer program product may have a first mode in which points in a selected subset are identified using unique data point identifiers, and a second mode in which points in a selected subset are defined using data parameters.

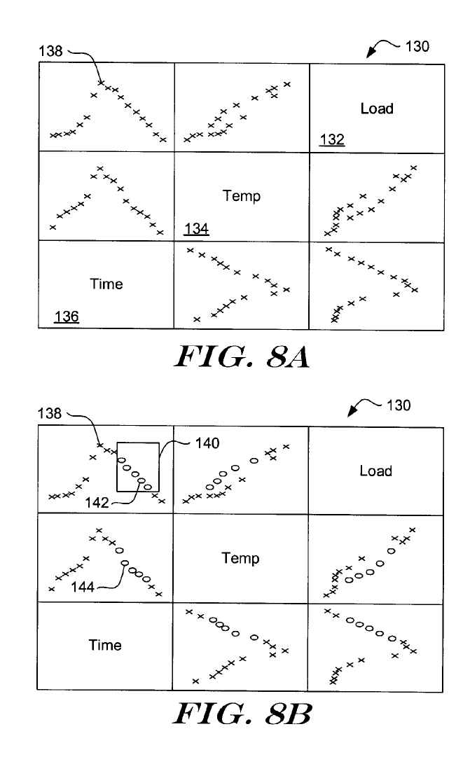

FIGS. 8A-8B show a highly simplified graphical selection of data points within a scatter plot matrix. The embodiment shown in FIGS. 8A-8B shows graphical display properties of some embodiments. Referring to FIG. 8A, a scatter plot matrix 130 has dimensions for load 132, temperature 134 and time 136. The scatter plot matrix 130 includes a number of data points 138. As displayed in FIG. 8A, either none or all of the data points 138 have been selected. Individual data points are not distinguishable from one another in the graphical display except for their position.

Referring to FIG. 8B, the scatter plot matrix 130 is now shown with a data subset having been graphically selected as shown by the box 140. Several data points 142 are within the data subset defined by the graphic box 140. In the other plots in the matrix, points within the data subset are shown using a different marker, as indicated at 144. While only a three-dimensional scatter plot matrix is shown in FIG. 8B, this manner of selection allows a user to literally see how a graphically selected subset appears in other dimensions. In various embodiments, points within the data subset may be displayed using different colors or shapes than non-selected data points. Multiple subsets may also be defined.

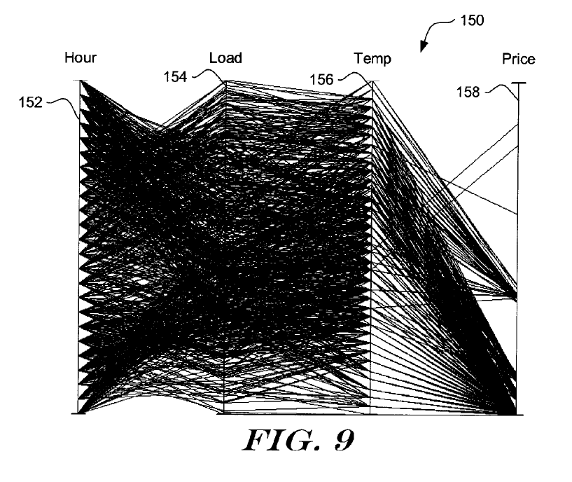

FIG. 9 illustrates parallel coordinate plotting of data. Specifically, in a parallel coordinate plot, a data point is shown as a multi-segment line that intersects each of a number of parallel coordinate axes. U.S. Pat. No. 5,546,516, the disclosure of which is incorporated herein by reference, shows several aspects of parallel coordinate plots. The illustrative plot 150 in FIG. 9 has four dimensions: hour 152, load 154, temperature 156, and price 158. Each line intersects each axis at a point indicative of the data point's value for that dimension.

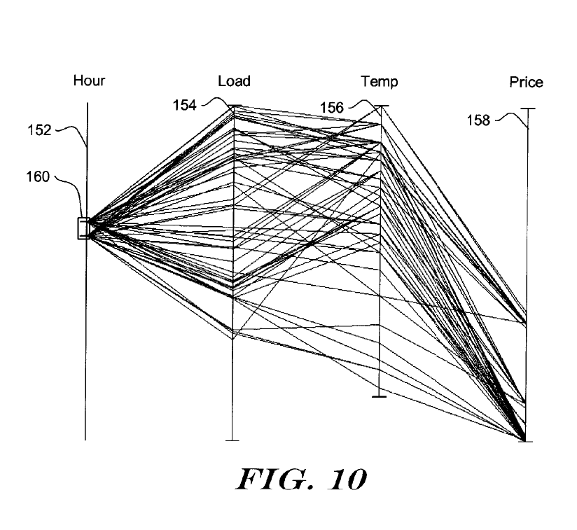

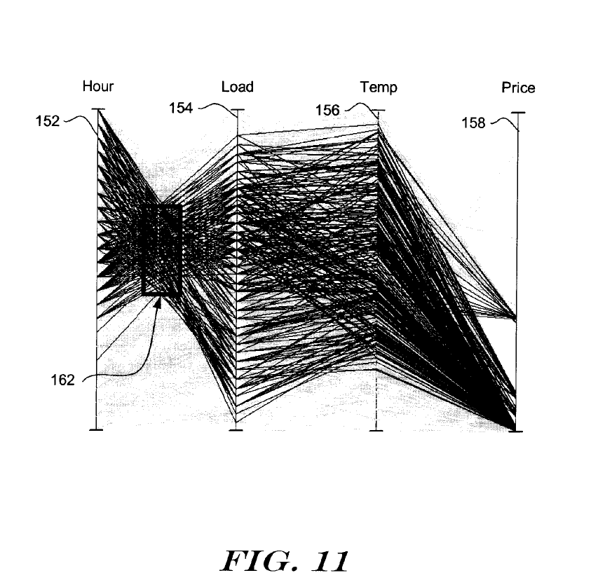

FIGS. 10-11 illustrate graphical selection of data points in parallel plots corresponding to the parallel plot of FIG. 9. Referring to FIG. 10, a box 160 is used to graphically select several data points. The selected data points are also shown crossing each of the axes 152, 154, 156, 158. The other lines in the original plot shown in FIG. 9 are omitted to highlight the lines selected. When displayed, for example, on a computer screen, the selected lines may be shown in a different color than non-selected lines, or, a display analogous to that shown may be used. An SQL statement generated in association with the graphical selection of FIG. 10 may be as follows:

SELECT Table1.Hour, Table1.Load, Table1.OutdoorTemperature,
Table1.UtilityPrice FROM Table1
WHERE Table1.Hour>=14 AND Table1.Hour<=15

Referring now to FIG. 11, graphical selection at a location that is between axes is shown. Specifically, selection box 162 is shown to indicate which of the data points represented in FIG. 11 are included. Selection box 162 is not, however, on one of the axes 152, 154, 156, 158, instead being located between two of the axes 152, 154. Each line that intersects a portion of the selection box 162 is thereby selected. For clarity, and as with FIG. 10, the data points that were not selected from FIG. 9 are again omitted. In some embodiments, data points for building SQL statement from a parallel coordinate plot may be identified by using analytical geometry methods, for example, by calculating intersections between parallel coordinate plot lines (representing individual data points) and the selection box 162.

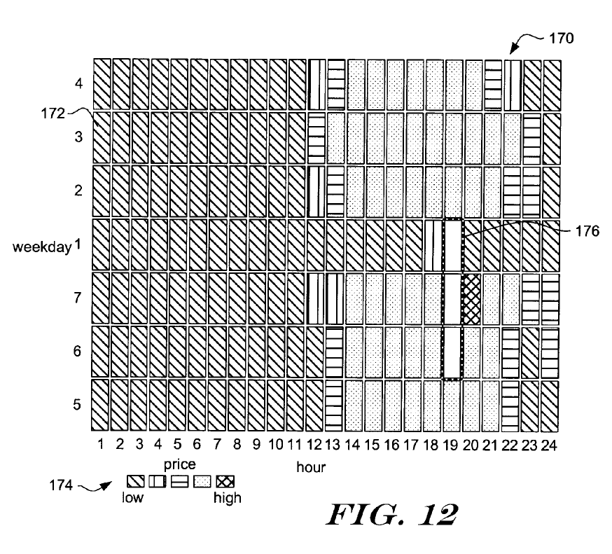

FIG. 12 shows graphical selection of data points from a mosaic representation of data. A mosaic plot provides a way of two-dimensional frequency analysis of categorical data. The size of a rectangle corresponds to observed cell frequency, i.e. the frequency of x-y categories having a given combination. The color or fill pattern of a rectangle represents some other statistical variable. The mosaic plot 1 70 displays the relationship between three dimensions of data using a plurality of blocks 1 72. In the illustrative example, the categorical dimensions include weekday and hour, shown on the chart axes, and, for example, mean price, indicated by the patterns on individual blocks using the scale shown at 174. Data points are represented as blocks 172. As shown, three rectangles are selected in the box at 176, and may represent numerous data points that meet the categorical limits on the three rectangles. For this example, the SQL statement that is built may take the following form:

SELECT Table1.Hour, Table1.Load, Table1.OutdoorTemperature,
Table1.UtilityPrice FROM Table1
WHERE Table1.hour=18 AND Table1.weekday IN (6,7,1)

The mosaic plot allows for categorical selection of a plurality of data points.

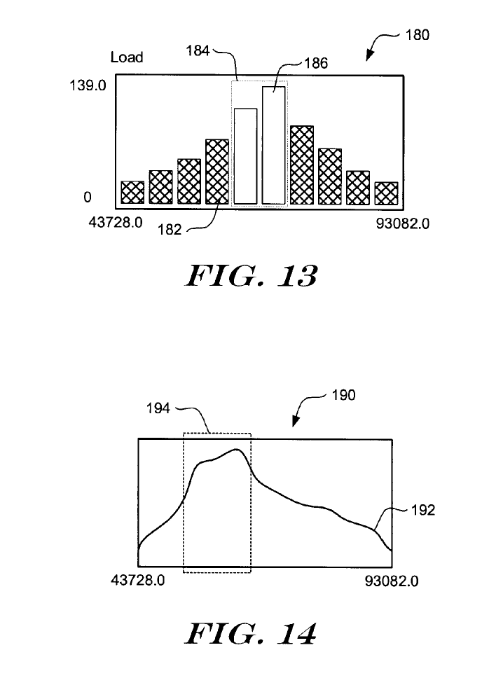

FIG. 13 illustrates graphical selection of data from a histogram. The histogram 180 indicates load levels by grouping sets of load levels and showing the frequency with which loads within certain bounds occur. Each bar 182 therefore represents a number of occurrences of a load having a value indicated by the lower axis of the chart. As indicated by block 184, two of the bars including bar 186 are selected. The following is illustrative of an SQL statement that may be made using the graphical selection shown in FIG. 13:

```
  SELECT Table1.Hour, Table1.Load, Table1.OutdoorTemperature,
  Table1.UtilityPrice FROM Table1
  WHERE (Table1.Load>Binlow1 AND Table1.Load<=Binhigh1) OR
(Table1.Load>Binlow2 AND Table1.Load<=Binhigh2)
```

For purposes of this illustrative SQL statement, Binlow N and Binhigh N represent the high and low bounds for the Nth histogram bar. The high and low bounds may be created or calculated in any suitable fashion. In some embodiments, the high and low bounds are calculated by equally dividing a range between maximum and minimum values for a variable to be considered in the histogram.

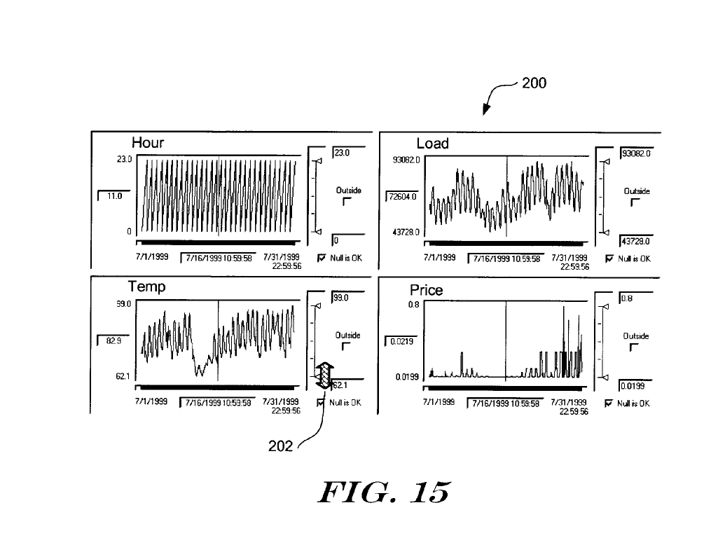

FIG. 14 illustrates graphical selection of data from a probability density function (PDF) representation of data. The PDF graph 190 shows line 192 which indicates the relative likelihood that a given variable will take the values shown at the bottom axis. Block 194 indicates a selected portion of the PDF graph. The selection shown includes those data points in which the variable under consideration in the PDF graph 190 has a value falling within the range shown on the lower axis and within block 194. A representative SQL statement is therefore:

SELECT Table1.Hour, Table1.Load, Table1.OutdoorTemperature,
Table1.UtilityPrice FROM Table1
WHERE Table1.Load>=SelectionLow AND Table1.Load<=SelectionHigh

For the SQL, the variables SelectionLow and SelectionHigh are set by observing the values of the lower axis at the edges of the block 194.

It should be noted that in the illustrative graphs shown in FIGS. 13 and 14, actual data points cannot be discerned from the graphs used in performing graphical selection of data points. Instead, the graphs of FIGS. 13-14 are derived from a collection of data points. Selection therefore occurs using data related to the set of data points.

The SQL statements generated above may be stored in memory for later or other uses. For example, an SQL statement generated as shown in any of the above embodiments may be saved for later use to repeat analysis on other databases or the same database at a later time, when data has been updated or replaced. Also, an SQL statement as generated above may be transferred to other programs for use in additional analysis.

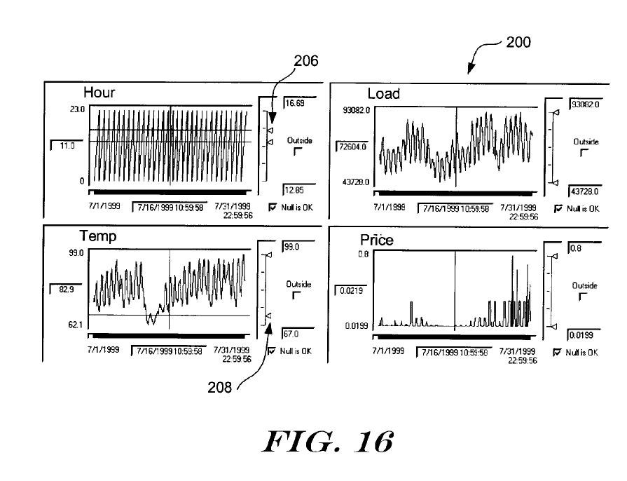

FIGS. 15-16 illustrate graphical selection for SQL statement-building from trend plots. The illustrative trend plots show variable trends displayed on a y-axis against time displayed on the x-axis. Referring to FIG. 15, four trend plots are shown for hour, load, temperature and price. For each of the four variables, a slider is shown having upper and lower bounds. Graphical selection using the multiple dimensions is allowed by movement of the slider bounds, such as at slider bound 202, which is the lower bound for the temperature dimension. FIG. 16 illustrates graphical selection using the trend plot 200. Here, upper and lower bounds for the hour plot have been set, as shown at 206. Also, a lower bound for the temperature plot has been selected, as shown at 214, with the upper bound of the temperature plot left at its maximum value. These selections select a number of data points. A representative SQL statement is:

```
  SELECT Table1.Hour, Table1.Load, Table1.OutdoorTemperature,
  Table1.UtilityPrice FROM Table1
  WHERE (Table1.OutdoorTemperature >=67 AND
Table1.OutdoorTemperature <=
99) AND (Table1.Hour >= 14 AND Table1.Hour <= 15)
```

The selection area can also be reversed by user option, for example, by checking an “inverse” or “outside” option. In this embodiment, data lying outside the upper and lower limits are then selected. Referring to the plot of FIG. 16, a representative “outside” SQL statement is:

```
    SELECT Table1.Hour, Table1.Load, Table1.OutdoorTemperature,
Table1.UtilityPrice
    FROM Table1
    WHERE (Table1.OutdoorTemperature <= 67 OR
Table1.OutdoorTemperature >= 99) AND (Table1.Hour <= 14 OR
Table1.Hour >= 15)
```

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

What is claimed is:

1. A computer program product for data analysis having instructions for performing the following steps:
graphically plotting a number of data points on a graphical user interface using at least a first and a second variable related to each data point;
allowing a user to graphically select a subset of the number of data points;
translating the action of the user in graphically selecting the subset into a database command related to data points represented in the graphically selected subset.

2. The computer program product of claim 1 wherein the step of translating includes translating into SQL.

3. A computer readable media embodying the computer program product of claim 1.

4. The computer program product of claim 1 wherein the step of graphically displaying the number of data points includes displaying the data points as raw data.

5. The computer program product of claim 1 wherein the step of graphically displaying the number of data points includes displaying information derived from the data points.

6. The computer program product of claim 1 wherein the step of allowing a user to graphically select a subset of the number of data points includes allowing the user to use a cursor to brush one or more data points.

7. The computer program product of claim 1 wherein the step of allowing a user to graphically select a subset of the number of data points includes allowing the user to define first and second non-contiguous graphic blocks of data points.

8. A method of data analysis comprising:
graphically plotting a number of data points on a graphical user interface using at least a first and a second variable related to each data point;
graphically selecting a subset of the number of data points;
translating the action of graphically selecting the subset into a database command related to data points in the graphically selected subset.

9. The method of claim 8 wherein the step of translating the action includes translating into SQL.

10. The method of claim 8 wherein the step of graphically displaying the number of data points includes displaying the data points as raw data.

11. The method of claim 8 wherein the step of graphically displaying the number of data points includes displaying information derived from the data points.

12. The method of claim 8 wherein the step of graphically selecting a subset of the number of data points includes using a cursor to brush one or more data points.

13. The method of claim 8 wherein the step graphically selecting a subset of the number of data points includes graphically defining first and second non-contiguous graphic blocks of data points.

14. A computer system comprising a central processing unit, memory, and a graphical user interface, the system configured for data analysis by use of the following steps:
graphically plotting a number of data points on a graphical user interface using at least a first and a second variable related to each data point;
allowing a user to graphically select a subset of the number of data points;
translating the action of the user in graphically selecting the subset into a database command related to data points represented in the graphically selected subset.

15. The computer system of claim 14 wherein the system is further configured such that the step of translating includes translating into SQL.

16. The computer system of claim 14 wherein the system is further configured such that the step of graphically displaying the number of data points includes displaying the data points as raw data.

17. The computer system of claim 14 wherein the system is further configured such that the step of graphically displaying the number of data points includes displaying information derived from the data points.

18. The computer system of claim 14 wherein the system is further configured such that the step of allowing a user to graphically select a subset of the number of data points includes allowing the user to use a cursor to brush one or more data points.

19. The computer system of claim 14 further comprising non-keyboard means for curser control wherein the system is further configured such that, in at least one mode of operation, the user uses the non-keyboard means for curser control to graphically select one or more data points.

20. The computer system of claim 14 wherein the system is further configured such that the step of allowing a user to graphically select a subset of the number of data points includes allowing the user to define first and second non-contiguous graphic blocks of data points.

21. A computer program product for data analysis having instructions for performing the following steps:
graphically representing data derived from a number of data points on a graphical user interface in a probability density function format;
allowing a user to graphically select a portion of the graphical representation; and
translating the action of the user in graphically selecting the subset into a database command related to data points represented in the graphically selected portion.
